(19) United States
(12) Patent Application Publication
(10) Pub. No.: US 2024/0057637 A1
(43) Pub. Date: Feb. 22, 2024

(54) MEAT-ANALOGUE COMPOSITION COMPRISING SATURATED FATTY ACIDS OF STEARIC AND LAURIC ACID RESIDUES

(71) Applicant: AAK AB, Malmo (SE)

(72) Inventor: Jeroen DEMEURISSE, Malmo (SE)

(21) Appl. No.: 18/259,440

(22) PCT Filed: Jan. 28, 2022
(86) PCT No.: PCT/SE2022/050092

§ 371 Date: Jun. 27, 2023

(30) Foreign Application Priority Data
Jan. 29, 2021 (SE) 2130028-0

(51) Int. Cl. A23J 3/22; A23J 3/14; A23L 33/12

(52) U.S. Cl. CPC A23J 3/227; A23J 3/14; A23L 33/12

(57) ABSTRACT

A meat analogue composition comprises from 2% to 20% by weight of a fat composition; from 5% to 30% by weight of a non-animal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

### FIELD OF THE INVENTION

The invention relates to meat analogue compositions comprising a fat composition, non-animal protein and water, and the use of said meat analogue compositions in food products. In particular, the invention relates to the use of certain fat compositions in meat analogue compositions to improve various properties of the meat analogue compositions.

### BACKGROUND OF THE INVENTION

There is an increasing demand for plant-based foods due to consumer's increasing desire to eat healthy, sustainably sourced food products and to generally lower their meat intake. This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of sizzling and browning during cooking, bleeding, colour, texture and taste. One example of such meat-analogues is plant-based burgers. Products such as plant-based sausages, meat balls, meat loaf and nuggets are also known in the art.

The typical composition of known meat-analogues is 50 to 60% water, 10 to 25% proteins (such as soy, pea, potato and wheat), 5 to 20% fat, 0 to 10% carbohydrates, as well as flavourings and colourings. Various fats have been proposed for use in meat analogue compositions. It is important that the fat is not an animal-derived fat such that the meat analogue composition is suitable for consumption by vegetarians and vegans. Accordingly, animal fats that are typically solid at room temperature are generally not used in meat analogue compositions. In order to produce a desirable meat-analogue, it is important that the final product have an appealing taste, texture and mouthfeel, and have similar taste, texture and mouthfeel to meat. Such properties are generally affected by the nature of the fat included in the meat analogue composition. The nature of the fat in meat analogue compositions also typically has an effect upon juiciness of the compositions and upon flavour release as the fats often function as carriers for fat soluble flavours. The nature of the fat is also important for the processability of the meat analogue dough such as during moulding of a meat analogue composition into burger patties. The nature of the fat is also important for providing visual similarity to meat products.

Coconut oil, palm oil, sunflower oil and rapeseed oil are examples of vegetable derived fats that have been proposed for use in meat analogue compositions. It is desirable that the fats have a relatively high melting point in order to mimic effects such as the taste, texture and mouthfeel of high melting point animal fats found in meats which are typically solid at room temperature. As a result, coconut oil and palm oil have attracted attention as they have relatively high melting points compared to other vegetable oils. Of these oils, coconut oil is typically preferred due to the negative environmental effects associated with the production of palm oil. Furthermore, palm oil contains a high amount of palmitic acid residues which is considered to be detrimental to cholesterol levels of consumers. A problem with both coconut oil and palm oil is that they are high in saturated fatty acids, which is generally considered unhealthy. The use of alternative oils lower in saturated fatty acid residues such as sunflower oil and rapeseed oil has been found to compromise desirable properties of meat analogue compositions due to the liquid nature of the oils. Properties such as juiciness are compromised and the liquid nature of the oils means that there is no structuring potential of the meat analogue composition resulting in oily meat doughs which create problems during moulding and processing of the meat analogue compositions. As a result, coconut oil remains the industry standard for the fat used in meat analogue compositions.

The inventors of the present invention have appreciated that there are various disadvantages of using coconut oil in meat analogue compositions. Firstly, as discussed above, coconut oil is high in saturated fatty acid residues which is undesirable for consumers from a health perspective due to the association of saturated fatty acid residues in fats with heart disease, undesirable cholesterol levels, and related conditions. The inventors of the present invention have also appreciated that coconut oil, despite having a relatively high melting point for a vegetable oil, has a steep melting curve. In other words at colder temperatures of less than 15° C., coconut oil is a hard brittle solid, whereas at higher temperatures of 30° C. to 35° C., the coconut oil is a liquid containing no or very little solid fat. It has been found by the inventors that the solid, hard brittle structure of coconut oil at lower temperatures means that the coconut oil is often difficult to process and sufficiently mix in with other components of the meat analogue composition during manufacture, meaning that it is sometimes desirable for the coconut oil to be melted or heated beforehand. This is undesirable in manufacturing processes due to the extra energy required to melt the coconut oil during manufacture. The inventors have also appreciated that in instances where solid, brittle particles of coconut oil are included in meat analogue compositions, said coconut oil particles have an edgy structure and appearance, which does not effectively resemble the structure of real meat where the fat particles are generally more rounded. On the other hand, where coconut oil is melted prior to inclusion in the meat analogue compositions, the resultant composition also does not effectively mimic the structure and appearance of real meat since the fat is dispersed uniformly within the composition to provide a homogenous structure and appearance which does not resemble how animal fat particles are dispersed within real meat. An additional disadvantage associated with the use of coconut oil is that its steep melting curve means that there is only a narrow temperature window in which coconut oil can be mixed into a meat analogue composition as a solid. It has also been found that having no solid fat at 30° C. to 35° C. is undesirable since this results in an overly quick release of fat/flavour from the meat analogue compositions. Many flavourants present in meat analogue compositions are fat soluble and so are released overly quickly on melting of the fat. A further disadvantage of coconut oil is that it often contains high levels of mineral oil saturated hydrocarbons (MOSH) and mineral oil aromatic hydrocarbons (MOAN).

It has been found by the inventors of the present invention that the use of certain fats in meat analogue compositions instead of coconut oil and other fats can address and/or alleviate many of the problems discussed above associated with the use of coconut oil and other fats in such compositions.

The documents discussed below discuss the utility of certain fat compositions in certain food products. However, the use of the fat compositions in meat analogue compositions, and the possible advantages associated therewith over the state of the art are not contemplated.

WO2019/185444 discloses non-hydrogenated fat compositions comprising from 3.2% to 10% by weight of total caprylic acid and capric acid; and from 13% to 32% by weight lauric acid; from 20% to 45% by weight stearic acid. The fat compositions contain from 7% to 15% by weight CN46 triglycerides; from 4% to 30% by weight CN54 triglycerides; and from 15% to 28% by weight of total CN42 and CN54 triglycerides. The fat compositions are disclosed for use in bakery and confectionary applications to improve the textural and sensory performance of baked goods and confections. In particular, the fat compositions are taught as being useful for inclusion in whipped cream compositions and beneficial for allowing air to be entrained therein.

EP2443935 discloses edible products comprising from 15% to 80% of a triglyceride composition; from 20% to 85% of at least one filler material and up to 15% water. The triglyceride compositions comprise from 20% to 70% by weight saturated fatty acid residues and up to 5% by weight of trans unsaturated fatty acid residues, and are high in lauric acid. The compositions are taught as being of high nutritional benefit compared to other high melting point vegetable derived fats due to the relatively low saturated fatty acid content and high lauric acid content. Fats with high lauric content are reported as being less likely to accumulate as body fat compared to fats containing a higher proportion of longer chain saturated fatty acids.

WO2016/162529 discloses triglyceride compositions having reduced saturated fatty acid contents and higher amounts of unsaturated fatty acids. The compositions are taught for use as oils for deep fat frying of food products. The oils are taught as having a better nutritional profile than conventional oils used in deep fat frying, and to provide crispiness and a lower risk of oil seeping out from deep fat fried food products. The deep fat fried products produced using the oil are also reported as having a less waxy mouth feel.

### SUMMARY OF THE INVENTION

The present invention is based upon the surprising finding that certain fat compositions solve or alleviate many of the problems discussed above associated with the use of coconut oil and other fats in meat analogue compositions. It has been found that the certain fat compositions have an improved nutritional profile relative to coconut oil due to having lower amounts of saturated fatty acid residues. Surprisingly, the inclusion of these fat compositions in meat analogue compositions in place of coconut oil has been found to not negatively affect, and in some cases improve various properties of meat analogue compositions such as various sensory properties of the compositions. It has been found that these certain fat compositions with improved nutritional profile provide improved juiciness to the meat analogue compositions when cooked or partially cooked, in comparisons to meat analogue compositions comprising an equivalent amount of coconut oil or liquid oils as sunflower oil or rapeseed oil. It has also been found that the use of the certain fat compositions in place of coconut oil also has a positive effect on the taste of the meat analogue composition once cooked. In particular, it has been found that the fat compositions provide a desirable “longer” flavour release when compared to compositions containing coconut oil. Without being limited by theory, this is believed to be due to the fat compositions containing higher amounts of solid fat at mouth temperatures of 30° C. to 35° C. A further advantage of the certain fat compositions compared to coconut oil is that they can be crystallised in a more ‘plasticised form’ meaning that said compositions are more ‘deformable’ than coconut oil at typical processing temperatures meaning that said fat compositions can be incorporated and mixed into meat analogue compositions more easily. Easier processability and manufacture is thus provided. The ability to admix the fat compositions into meat analogue compositions without melting has also been found useful by the inventors to provide heterogeneity to the surfaces of food products containing the meat analogue compositions meaning that said food products more closely mimic the visual appearance of meat, compared to meat analogue compositions where the fat is melted prior to mixing with the other components of the composition. For example, hard brittle structures of the fat compositions can be provided and mixed into the meat analogue compositions which mimic the effect of “marbling” in meat compositions. Alternatively, plasticised fat structures of crystallised fat can be provided and mixed with other components of a meat analogue composition. Such plasticised fat structures have the further advantage of creating less edgy fat pieces, more resembling the appearance of intramuscular fat in real meat, in comparison to where solid coconut oil structures are included that have an edgier structure and appearance. A further advantage of the compositions for use in the invention is that since they have higher melting points than coconut oil, where it is desired to include solid fat particles in the meat analogue compositions, processing can be done at higher temperatures than coconut oil without the fat particles melting. The fat compositions thus improve both the nutritional value and sensory properties of the finished meat analogue composition product.

According to a first aspect of the invention, there is provided a meat analogue composition comprising from 2% to 20% by weight of a fat composition; from 5% to 30% by weight of a non-animal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

Preferably, the fat composition comprises from 20% to 70% by weight of saturated fatty acids, and more preferably from 20% to 60% by weight of saturated fatty acids. In some embodiments, the fat composition comprises 65% to 85% by weight of saturated fatty acids. In other embodiments, the fat composition comprises from 20% to 65% by weight of saturated fatty acids. The amount of saturated fatty acid residues present in the fat composition may be tailored so as to provide the specific desired properties of the fat composition. For example, where the fat composition comprises a higher saturated fat content of from 65% to 85% by weight, the fat composition may be particularly useful for providing hard, brittle solid structures of fat that can be easily admixed with other components of the meat analogue composition so as to provide a “marbling effect” to the meat analogue composition or a food product containing the meat analogue composition. Such fat compositions may thus be used to provide greater heterogeneity to the surfaces of food products such as burgers and more closely mimic the appearance of real meat. In other embodiments, the fat compositions comprise from 20% to 65% by weight of saturated fatty acids. Said fat compositions have been found useful in providing the plasticized fat structure effect described above.

Typically, the fat composition comprises from 2 to 12 percent by weight of St2M triglycerides, preferably from 5 to 12 percent by weight of St2M triglycerides. A St2M triglyceride is a triglyceride molecule comprising two stearic acid residues and one residue of either lauric acid or myristic acid. Without being limited by theory, it has been found that fat compositions comprising St2M triglycerides in the amounts specified above aids in providing both the plasticized fat structure effect and the solid brittle structure marbling effect described above. The St2M triglycerides crystallise fast and bind oil well which aids in the provision of the effects discussed above.

Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48.

Preferably, the fat composition comprises less than 10% by weight of palm oil, more preferably less than 5% by weight of palm oil, and still more preferably less than 2% by weight of palm oil. Most preferably the composition does not comprise palm oil.

The fat composition preferably is a non-hydrogenated fat composition.

The fat composition preferably comprises a greater amount of stearic acid than palmitic acid. This is advantageous from a nutritional perspective since stearic acid has a neutral effect upon total cholesterol and LDL cholesterol levels, whereas palmitic acid is known to increase total cholesterol and LDL cholesterol levels. Typically, the fat composition comprises 20% by weight or less, and preferably 10% by weight or less of palmitic acid (C16:0). Typically, the fat composition has a weight ratio of stearic acid (C18:0) to palmitic acid (C16:0) of from 1:1 to 12:1. Typically, the fat composition has a weight ratio of lauric acid (C12:0) to stearic acid (C18:0) of from 1:4 to 4:1. Preferably, the fat composition comprises from 10% to 25% by weight lauric acid (C12:0); and/or from 15% to 45% by weight stearic acid (C18:0). More preferably, the fat composition comprises from 10% to 25% by weight lauric acid (C12:0); and from 15% to 45% by weight stearic acid (C18:0).

Typically, the fat composition has one or more of the following properties.
(i) the fat composition has a solid fat content (SFC) N40 of less than 10, measured on unstabilised fat according to ISO 8292-1, preferably from 1 to 9, and more preferably from 2 to 8;
(ii) the fat composition has a solid fat content (SFC) N20 of from 35 to 60, preferably from 25 to 56, more preferably from 20 to 40, as measured on the unstabilised fat according to ISO 8292-1; and
(iii) the fat composition has a solid fat content (SFC) N30 of from 5 to 35, preferably from 8 to 32; more preferably from 8 to 30, as measured on the unstabilised fat according to ISO 8292-1.

Preferably, the fat composition has all three of the above properties.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

The fat composition may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

Preferably, the fat composition comprises an interesterified fat, and more preferably wherein the fat composition comprises an interesterified fat blend. The interesterified fat or interesterified fat blend may be produced by chemical interesterification, enzymatic interesterification, or a combination thereof.

In some embodiments, the interesterified fat or interesterified fat blend is produced by an enzymatic interesterification reaction which does not reach an equilibrium product distribution. It has been found that these embodiments provide a fat composition product with optimum properties for use in a meat analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3^{rd} Edition, pages 285-300 (F. D. Gunstone, J. L. Harwood, and A. J. Dijkstra (eds.), Taylor & Francis Group LLC, Boca Raton, FL) (2007).

Preferably, the fat composition comprises an interesterified fat blend comprising a vegetable oil high in stearic acid and a vegetable oil high in lauric acid. Preferably, the vegetable oil high in stearic acid is also high in monounsaturated fatty acids such as oleic acids. Accordingly, in typical embodiments, the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

In preferable embodiments, the fat composition comprises an interesterified blend of shea butter and coconut oil or an interesterified blend of shea stearin and coconut oil. For example, in some embodiments, the fat composition comprises an interesterified blend of from 20% to 80% by weight of shea butter and from 20% to 80% by weight of coconut oil. In other embodiments, the fat composition comprises an interesterified blend of from 20% to 80% by weight of shea stearin and from 20% to 80% by weight of coconut oil.

In highly preferable embodiments, the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil. Preferably, the fat composition is present in the meat analogue composition in an amount of from 7.5% to 20% by weight of the meat analogue composition.

Preferably, the fat composition contains a substantially major portion of fat with very little water (i.e. the fat composition consists essentially of fat molecules). However, in some embodiments, the fat composition may contain water and be present in the form of an emulsion such as an oil-in-water emulsion or a water-in-oil emulsion, typically with a suitable emulsifier. In such embodiments, the weight percentage ranges provided above for the amount that the fat composition is present in the meat analogue composition refers to only fat molecules present in the fat composition, and not any water present in the composition. Similarly, the weight percentages given above for the amount of water present in the meat analogue composition refers to both water added in its own right during manufacture of the meat analogue composition, and also to any water present in other components of the meat analogue composition (such as water present in an emulsified fat composition), or water bound to any protein, as discussed in further detail below.

In some embodiments, the meat analogue composition comprises a fat composition comprising an interesterified fat blend as described above and at least one additional fat or oil. Preferably, the at least one additional fat or oil comprises a lauric vegetable oil. More preferably, the at least one additional fat or oil comprises coconut oil, coconut oil stearin, coconut oil olein, palm kernel oil, palm kernel olein, palm kernel stearin, babassu oil, or mixtures thereof. Most preferably, the at least one additional fat or oil comprises coconut oil. In these embodiments, the fat composition preferably comprises the interesterified fat blend in an amount of from 50% to 80% by weight of the fat composition and a total amount of additional fat or oil in an amount of from 20% to 50% by weight of the fat composition. More preferably, the fat composition comprises the interesterified blend described above in an amount of from 60% to 80% by weight of the fat composition and a total amount of additional fat or oil in an amount of from 20% to 40% by weight of the fat composition.

The meat compositions of the invention comprise one or more non-animal proteins, such as one or more proteins derived from fungi, plants, or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, or a combination thereof.

More preferably, the non-animal protein comprises texturized vegetable proteins, preferably wherein the texturized vegetable proteins comprise texturized pea proteins, texturized fava proteins, texturized soy proteins, texturized wheat proteins or a combination thereof. Preferably, the texturized vegetable protein is present in the meat analogue composition in an amount of from 10% to 20% by weight of the meat analogue composition.

The non-animal protein is present in the meat analogue composition in an amount of from 5% to 30% by weight of the meat analogue composition. Preferably, the non-animal protein is present in the meat analogue composition in an amount of from 10% to 30% by weight of the meat analogue composition, and more preferably from 15% to 30% by weight of the meat analogue composition.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10 to 20 wt. % of protein. Typically, when hydrated TVPs can contain up to 3 to 4 times their dry weight in water. As discussed above, the weight percentage ranges referred to above for water present in the meat analogue compositions include both water added in its own right and water present in other components of the meat analogue composition such as in textured vegetable proteins or emulsified with fat. Similarly, the weight percentage ranges given above for the amount of non-animal protein present in the meat analogue composition refer to dry weight of protein, and do not include water bound to the non-animal protein such as in textured vegetable protein.

The plant protein used in the preparation of the meat-analogue composition may be either dry (also referred to as ‘dry phase’ herein) or moist. Thus, in embodiments, the plant protein may be included in a dry mix of ingredients, which may include additional ingredients intended for inclusion in the meat-analogue composition, such as carbohydrates, fibre and/or hydrocolloids, in addition to protein. If the plant protein is dry, it may be hydrated prior to and/or during the formation of the meat-analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the aw of the dry phase is 0.90 or lower, more preferably below 0.80. The dry phase comprising plant protein is typically provided in a substantially dehydrated state to reduce microbial growth as far as possible so as to extend shelf life.

The meat-analogue composition comprises water, which may be added as a separate component to the composition, or derive from other components of the composition as discussed above. The amount of water is not particularly limited and, as the skilled person will appreciate, will vary depending on the intended consistency of the meat-analogue composition. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

The meat analogue composition typically comprises one or more additional ingredients. Whilst these one or more additional ingredients may be preferable to include in the meat analogue compositions, it will be understood that the inclusion of the one or more additional ingredients is not essential.

The meat analogue composition preferably further comprises a stabilizer blend. Preferably, the stabilizer blend is present in the meat analogue composition in an amount of from 5% to 10% by weight of the meat analogue composition. Typically, the stabilizer blend comprises vegetable derived protein, vegetable fibre and/or a polysaccharide. Preferably, the vegetable derived protein comprises pea protein, the vegetable fibre comprises pea fibre, and/or the polysaccharide comprises methylcellulose. In highly preferred embodiments, the stabiliser blend comprises vegetable derived protein comprising pea protein, vegetable fibre comprising pea fibre, and polysaccharide comprising methylcellulose.

The meat analogue composition may comprise one or more flavouring additives. Preferably, the one or more flavouring additives are present in an amount of from 0.5% to 2% by weight of the meat analogue composition. Suitable flavouring additives known in the art may be used in the meat analogue compositions.

The meat analogue composition may comprise one or more colouring additives. Typically, the one or more colouring additives are present in an amount of f rom 0.5% to 5% by weight of the meat analogue composition. Suitable colouring additives known in the art may be used in the meat analogue compositions.

In some embodiments, the meat analogue composition further comprises one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the meat analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, acidity regulators, or combinations thereof.

Amino acids are a preferred additive for the meat-analogue compositions of the invention, since these are known to contribute to the Maillard reaction, a form of non-enzymatic browning resulting from the chemical reaction between amino acids and sugars upon heating. This is used in flavour development of cooked foods and this reaction can be used in the meat-analogue composition to replicate the taste of meat by creating savoury meaty flavours.

In preferable embodiments, the meat analogue is suitable for consumption by vegetarians and vegans. Accordingly, in preferable embodiments, the meat analogue composition is substantially free of animal protein, and more preferably, the meat analogue composition is free of animal protein.

In preferable embodiments, the meat analogue composition is substantially free of animal-derived products, and more preferably, the meat analogue composition is free of animal-derived products.

However, in some embodiments, the meat analogue compositions may comprise animal-derived products such as animal derived proteins or fats. Accordingly, in some embodiments, the meat analogue composition further comprises one or more animal-derived products such as animal oils, marine oils, animal-derived proteins, animal-derived polysaccharides, or any combination thereof. In some embodiments, the one or more animal-derived products comprise animal milk proteins, animal milk fats, or a combination thereof. In these embodiments, the meat analogue compositions may be suitable for consumption by vegetarians on the basis that they comprise non-animal protein and proteins or fats derived from animal milk. These meat analogue compositions are suitable for consumption by vegetarians since they do not include fats or proteins derived from meat. However, it will of course be understood that such meat analogue compositions are not suitable for consumption by vegans.

In embodiments where the meat analogue compositions comprise one or more animal-derived products, the one or more animal-derived products are typically present in the meat analogue composition in an amount of from 1% to 20% by weight of the meat analogue composition.

According to a second aspect of the invention, there is provided a food product comprising a meat analogue composition of the invention. The food product may be an uncooked food product, a cooked food product, or a partially cooked food product.

Typically, the food product is a vegetarian or vegan meat substitute food product. Preferably, the vegetarian or vegan meat substitute food product is a burger, sausage, meat ball, nugget, patty, mince product, meatloaf, or other product intended to mimic conventional meat-based food products.

The properties of the meat-analogue composition or food products prepared using the composition may be measured by any suitable means. Properties of interest may include juiciness (and/or dryness), hardness, adhesiveness, springiness, cohesiveness, gumminess, chewiness and resilience. Such means include taste testers, which can provide feedback on properties of the composition or food product such as juiciness (or dryness), texture, chewiness and hardness. Typically multiple testers will be asked to mark one or more properties of the composition or food product, such as on a scale from 1 to 5. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. Gumminess is defined as the product of hardness×cohesiveness. Chewiness is defined as the product of gumminess×springiness (hardness×cohesiveness×springiness). In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess.

Gumminess is defined as the product of hardness×cohesiveness and is a characteristic of semisolid foods with a low degree of hardness and a high degree of cohesiveness.

Chewiness is defined as the product of gumminess×springiness (which equals hardness×cohesiveness×springiness) and is therefore influenced by the change of any one of these parameters.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

According to a third aspect of the invention, there is provided the use of a fat composition in a meat analogue composition, wherein the fat composition comprises from 20% to 80% by weight of saturated fatty acids; from 10% to 50% by weight of stearic acid (C18:0); and from 2% to 35% by weight of lauric acid (C12:0).

Preferably, the use further comprises using the meat analogue composition in a food product.

Preferably, the meat analogue composition, fat composition and/or food product are as described above.

The use may comprise using the fat composition to improve the nutritional profile of the meat analogue composition when compared to an analogous meat analogue composition comprising the same amount by weight of coconut oil. The term analogous meat analogue composition as used herein is used to refer to an equivalent weight of a meat analogue composition that is identical to the meat composition of the invention, with the exception of the nature of the fat present therein. The analogous meat analogue composition contains the same amount by weight of coconut oil as the meat analogue composition of the invention contains the fat composition. The nutritional profile of the meat analogue composition of the invention may be improved in comparison to coconut oil since it contains a lower total amount of saturated fatty acid residues per unit weight than coconut oil. Coconut oil contains around 90% saturated fatty acid residues. Without being limited by theory, it is believed that fats with higher saturated fatty acid contents increase the risk of heart disease, high blood pressure and associated conditions, and also have a detrimental effect upon the cholesterol levels of consumers. Accordingly, in some embodiments, the use comprises using the fat composition to improve the effect on in vivo cholesterol levels in a consumer of the meat analogue composition when compared to an analogous meat analogue composition comprising the same amount by weight of coconut oil, although it will be appreciated that other health and wellbeing benefits may also be realised by the use of the fat compositions in meat analogue compositions in place of coconut oil and similar fats.

The use may comprise using the fat composition to provide delayed release of flavours from the meat analogue composition when cooked and consumed when compared to an analogous meat analogue composition comprising the same amount by weight of coconut oil, and/or an analogous meat analogue composition comprising the same amount by weight of sunflower oil. Without being limited by theory, the delayed release of flavours compared to coconut oil is believed to be due to the fat compositions having a higher solid fat content than coconut oil at mouth temperatures of from 30° C. to 35° C. Many flavour and flavouring additive compounds are fat soluble and so are dissolved within the fat of the meat analogue composition. With a higher solid fat content, the release of the dissolved flavours from the fat is delayed over a longer period of time. The delayed release of flavours is believed to enable the meat analogue composition to more closely resemble the mouth feel and delayed flavour release of meat, which contains higher melting point fats which typically have higher solid fat contents at mouth temperature. A further resulting benefit is that less fat is required, which results in a number of further advantages as described herein.

The use may comprise using the fat composition to provide improved juiciness of the meat analogue composition when cooked when compared to an analogous meat analogue composition comprising the same amount by weight of coconut oil, and/or an analogous meat analogue composition comprising the same amount by weight of sunflower oil. Improved juiciness of the meat analogue composition or a cooked food product comprising the composition is also believed to make the meat analogue composition more closely resemble the mouth feel, juiciness and succulence of meat products. A further resulting benefit is that less fat is required, which results in a number of further advantages as described herein.

The use may comprise using the fat composition to provide increased heterogeneity, or an increased resemblance to real meat, of a surface of a cooked food product comprising the meat analogue composition when compared to an analogous food product comprising an analogous meat analogue composition comprising the same amount by weight of coconut oil, and/or an analogous meat analogue composition comprising the same amount by weight of sunflower oil. Typically, the use comprises using the fat composition to provide increased heterogeneity of a surface of a cooked food product comprising the meat analogue composition when compared to an analogous food product comprising an analogous meat analogue composition comprising the same amount by weight of sunflower oil. Alternatively or additionally, the use may comprise using the fat composition to provide an increased resemblance to real meat of a surface of a cooked food product comprising the meat analogue composition when compared to an analogous food product comprising an analogous meat analogue composition comprising the same amount by weight of coconut oil. In this latter embodiment, typically, the fat compositions are in the form of the plasticized fat structures discussed above. As discussed above, a disadvantage of coconut oil is that it is a hard and brittle structure at a temperature of from 0° C. to 15° C., meaning that the fat particles have an edgy structure and appearance within this temperature range. In contrast, in certain meat analogue compositions of the invention, plasticized fat structures are more rounded and less edgy in shape, which more closely mimics the appearance of intramuscular fat in real meat.

As discussed above, coconut oil is often melted prior to admixture with the other components of the composition on manufacture. This results in the meat analogue composition having a more homogenous structure, which does not mimic the visual appearance of real meat. Real meat tends to have a more heterogeneous structure, with visible solid fat structures (marbling) present on the surfaces of the meat product. The fat compositions described herein can be effectively processed and mixed with the other ingredients of the meat analogue composition during manufacture without melting. This results in a substantially uniform dispersion of the fat composition in the meat analogue compositions, but with larger, solid, visible fat particles than when molten fat is included. The surfaces of food products made from the meat analogue compositions thus more closely resemble the visual appearance of real meat, and have increased heterogeneity compared to meat analogue compositions containing melted fats.

The use may comprise using the fat composition to provide improved processability to the meat analogue composition when compared to an analogous meat analogue composition comprising the same amount by weight of coconut oil, and/or an analogous meat analogue composition comprising the same amount by weight of sunflower oil. Improved processability and handleability is provided, for example, by the fat compositions having higher melting points than coconut oil, meaning that solid particles of the fat can be processed and mixed with other components of a meat analogue composition at higher temperatures without melting. Such processability is desirable, for example, when it is desired to include fat particles in the meat analogue compositions in solid form.

According to a fourth aspect of the invention, there is provided a process of manufacturing a meat analogue composition of the invention or a food product of the invention.

Preferably, there is provided a process of manufacturing a meat analogue composition of the invention, or a food product of the invention, wherein the process comprises:
(a) providing a mixture of water and non-animal protein;
(b) combining the mixture from step (a) with the fat composition and optionally one or more additional components to form the meat analogue composition; and
(c) optionally forming the meat analogue composition into food products.

Preferably, the process further comprises cooking the food product to form a cooked food product or partially cooked food product.

Preferably, the process further comprises blending (i) the mixture of water and non-animal protein provided in step (a); (ii) a mixture formed in step (b) by combining the mixture from step (a) with the fat composition and optionally one or more additional components; and/or (iii) blending the one or more additional components with water prior to combination of the one or more additional components with the mixture from step (a) and fat composition.

Preferably, the fat composition is not melted prior to combining with the mixture from step (a) and optionally one or more additional components.

Whilst the above described steps are preferable steps for manufacturing the meat analogue compositions or food products described herein, it will be appreciated that other suitable processes may also be used to manufacture the meat analogue compositions and food products.

The meat-analogue composition of the present invention may be readily prepared by blending a fat composition as described herein with plant protein and any other components of the composition. In one embodiment, there is provided a process for preparing a meat-analogue composition, said process comprising the step of: forming the meat-analogue composition by blending a plant protein with a fat composition as described herein. Optionally, further ingredients may be present. Water may be added to the composition if required at any stage during the process. The process may further comprise the step of preparing the plant protein by providing a dry phase comprising plant protein and blending the dry phase with an amount of water, which precedes the step of forming the meat-analogue composition. This step may also include other ingredients which are in dry form, such that these dry ingredients are hydrated simultaneously with the plant protein. Additionally and/or alternatively, any other dry ingredients may be hydrated separately from the plant protein in any combination. In embodiments which include TVPs, the TVP is preferably hydrated separately from any other dry ingredients. Without being bound by theory, this is believed to limit competition between the dry components for the water and ensure satisfactory hydration for all dry components present.

Thus, disclosed herein is a process for preparing a meat-analogue composition, said process comprising the steps of: a) providing a dry phase comprising plant protein and optionally any other dry ingredients of the composition and blending the dry phase with an amount of water to form a mixture; b) forming the meat-analogue composition by blending the mixture formed in step a) with a fat composition as described herein. In embodiments, the plant protein may comprise TVPs. Preferably, dry ingredients other than the plant protein are hydrated separately from the plant protein. Examples of such dry ingredients include, but are not limited to, fibres, flavours, emulsifiers, gums, hydrocolloids, thickeners. In embodiments, the mixture of step a) comprising the hydrated plant protein and any other mixtures comprising hydrated dry ingredients are combined prior to step b). Without being bound by theory, it is believed that the hydration of dry ingredients prior to the addition of the fat composition (for example, in step a)) results in an optimal distribution of water in the product, resulting in a more stable meat-analogue composition.

The dry phase comprising plant protein used in the above process is not particularly limited. The plant protein is as described hereinabove. The term ‘dry phase’ is intended to mean that the phase comprising plant protein comprises less than 5 wt. % water, preferably less than 2 wt. % water, more preferably less than 1 wt. % water, even more preferably that it is substantially free from water. In other preferred embodiments, the aw of the dry phase is 0.90 or lower, more preferably below 0.80. The dry phase comprising plant protein is typically provided in a substantially dehydrated state to reduce microbial growth as far as possible so as to extend shelf life.

The dry phase, which may comprise plant protein, may take any physical form before being blended with water, however typically it is in powder, granule or pelletized, strip or chunk form. The amount of water added to the dry phase is not particularly limited. Typically, an amount of water is added in order to bind the dry components into a paste or dough with which the fat composition may be readily blended. The amount of water added to the dry phase is preferably calculated such that the total amount of water in the meat-analogue composition after addition of the other components of the fat composition are within the ranges described above.

The temperature of the water added is not particularly limited, so long as it does not materially impact the intended characteristics of the components (e.g. does not lead to protein denaturation or hydrolysis). In preferred embodiments, the water is below room temperature (i.e. below 20° C.). In particularly preferred embodiments, ice water is used. This is particularly preferred when water is added to the dry phase. The term “ice water” is defined herein as having a temperature of above 0° C. and below 6° C., preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose.

The blending of the dry phase with water may be performed for any duration of time. In embodiments, blending is performed until the dry phase and water are intimately mixed and typically until a paste or dough is formed. In embodiments in which TVPs are hydrated, blending is limited to a minimum so as not to overly disturb the fibrous structures. In embodiments this may be performed for a duration of from 1 minute to 30 minutes, preferably from 1 minutes to 10 minutes, more preferably from 5 seconds to 5 minutes.

Following blending of the dry phase and water, for example in step a), the mixture may be allowed to rest prior to the addition of the fat composition, for example in step b). This may ensure full hydration of the dry phase prior to addition of the fat composition. This rest may be performed under cold storage (thereby further controlling microbial growth), which has a temperature of from 0.5 to 15° C., preferably from 1 to 12° C., more preferably from 5 to 10° C. This rest may be performed for a duration of from 5 minutes to 5 hours, preferably from 5 minutes to 2 hours, more preferably from 5 minutes to 30 minutes.

Preparation of the meat-analogue composition may also comprise the step of adding further ingredients to the composition. These ingredients may be added at any stage in the preparation of the meat-analogue composition. In embodiments, further ingredients are added after the addition of the fat composition, for example after step b). Preferably, dry ingredients are hydrated prior to addition to the fat composition. In embodiments, dry ingredients are hydrated with any dry plant protein, such as in step a), prior to the addition of the fat composition. Such ingredients may include one or more of carbohydrates, polysaccharides, modified polysaccharides, hydrocolloids, gums, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators, as disclosed in more detail herein. The addition of these ingredients may be performed by blending, mixing or any suitable means.

Once the meat-analogue composition has been prepared, this may be formed into a food product. This may include the step of forming the meat-analogue composition into the desired shape. The shape and size of the resulting food product is not particularly limited. Examples of shaped food products which can be made from the meat-analogue composition according to the present invention include burgers, sausages, nuggets, meatballs and mince.

Any suitable method may be used to shape the meat-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat.

The process of preparing a meat-analogue composition may further comprise cooking or part-cooking the composition, which may have been formed into a food product. Cooking may comprise boiling, baking, frying and/or microwaving. In preferred embodiments, cooking is at sufficient temperature such that the Maillard reaction may occur (f or example, above 80° C. and up to 180° C., preferably from 130° C. to 170° C.). The Maillard reaction is useful for desirable browning of the food product.

### DESCRIPTION OF THE DRAWINGS

FIG. 1 compares photographs of cooked burgers according to the invention with comparative cooked burgers comprising coconut oil.

### DETAILED DESCRIPTION OF THE INVENTION

The following examples are for illustrative purposes only, and are not intended to limit the scope of the invention in any way.

### Example 1

Comparative fats sunflower oil and coconut oil were used.

Fat A was prepared by chemical interesterification of a blend of 70 wt % shea butter and 30 wt % coconut oil.

Various properties of Fat A are shown in Table 1 below and contrasted against comparative fats coconut oil and sunflower oil.

TABLE 1

| | Comparative fat | Comparative fat | |
|---|---|---|---|
| | sunflower oil | coconut oil | Fat A |
| Fatty acid residue | | | |
| concentrations | | | |
| (wt %) | | | |
| C4:0 | 0.0 | 0.0 | 0.0 |
| C6:0 | 0.0 | 0.6 | 0.2 |
| C8:0 | 0.0 | 8.0 | 2.4 |
| C10:0 | 0.0 | 5.9 | 1.8 |
| C12:0 | 0.0 | 47.6 | 14.3 |
| C14:0 | 0.1 | 18.1 | 5.4 |
| C16:0 | 5.5 | 9.0 | 4.6 |
| C18:0 | 3.5 | 2.9 | 32.9 |
| C18:1c | 27.7 | 6.2 | 32.4 |
| C18:1tr | 0.0 | 0.0 | 0.0 |
| C18:2c | 61.2 | 1.5 | 4.7 |
| C18:2tr | 0.5 | 0.0 | 0.0 |
| C18:3 | 0.3 | 0.0 | 0.1 |
| C20:0 | 0.3 | 0.1 | 1.0 |
| SAFA | 10.1 | 92.2 | 62.7 |
| Carbon Number | | | |
| 26 | 0.0 | 0.2 | 0.0 |
| 28 | 0.0 | 0.8 | 0.0 |
| 30 | 0.0 | 2.0 | 0.0 |
| 32 | 0.0 | 10.3 | 0.2 |
| 34 | 0.0 | 14.4 | 0.4 |
| 36 | 0.2 | 17.5 | 0.7 |
| 38 | 1.5 | 16.5 | 2.0 |
| 40 | 0.0 | 10.1 | 2.1 |
| 42 | 0.0 | 7.2 | 5.5 |
| 44 | 0.0 | 4.0 | 7.4 |
| 46 | 0.0 | 2.2 | 5.8 |
| 48 | 0.2 | 2.2 | 22.6 |
| 50 | 1.4 | 4.0 | 9.3 |
| 52 | 17.6 | 3.8 | 7.2 |
| 54 | 74.4 | 3.7 | 35.4 |
| 56 | 3.1 | 0.0 | 1.7 |
| CN46 + 48 | 0.2 | 4.4 | 28.4 |
| St2M | 0.0 | 0.3 | 6.4 |
| SFC10° C. | 0 | 81 | 54 |
| SFC20° C. | 0 | 38 | 28 |
| SFC30° C. | 0 | 0 | 9 |
| SFC35° C. | 0 | 0 | 4 |
| SFC40° C. | 0 | 0 | 1.5 |

It can also be seen that Fat A has a higher solid fat content at mouth temperature of from 30° C. to 35° C. As discussed above, this is believed to contribute to longer flavour release from the meat analogue compositions when consumed. It can also be seen that Fat A has a lower saturated fatty acid residue content than coconut oil, and also contains a greater content of C46 and C48 triglycerides, and also St2M triglycerides. The latter are fast crystallising triglycerides, which contribute towards the structure building properties of the fat composition.

General Method for Preparation of Plant-Based Burgers Using Texturised Proteins

Burgers were made from meat analogue compositions comprising Fat A (i.e. a meat analogue composition according to the invention), and from meat analogue compositions comprising coconut oil and sunflower oil.

The following procedure was used for the preparation of the plant-based burgers of the following examples:
1. The texturised proteins⁺⁺ were hydrated with cold water (5° C.) according to the quantities shown in Table 2 and further hydrated for at least 30 minutes in cold storage (5° C.);
2. All other ingredients in powder form (stabilizer blend⁺⁺⁺ and flavours) were mixed and hydrated with ice water (1-3° C.) by blending for at least 1 minute, following which they were stored in a fridge for at least 30 minutes;
3. The hydrated texturized proteins were chopped for 20 seconds at low speed;
4. The ingredients from steps 2 and 3 and any further ingredients (e.g. colours, fats in molten form, oils) according to the quantities shown in Table 2 were combined at room temperature and the resulting dough blended for about 2 mins;
5. The dough was rested in a fridge (operating at a temperature from 2 to 5° C.) for at least 30 minutes;
6. Burgers (diameter 10 cm; height 1.4 cm; weight 100 g) were made from this dough and stored in the fridge (operating at a temperature from 2 to 5° C.) prior to cooking; and
7. Samples were fried on a table grill at 220° C. to a core temperature of 72° C. (approximately 5-5:30 min). ⁺⁺ The texturised proteins referred to above are a blend of textured pea proteins (protein content minimum 70%; format: strips) and textured fava proteins (protein content minimum 60%; format: chunks).+++ The stabiliser blend referred to above is a blend of pea proteins (protein content minimum 83%; format: powder), pea fibre and methylcellulose.

The compositions of the burgers of Comparative Example 1, Comparative Example 2 and Example 3 are prepared according to the above method and are shown below in Table 2.

TABLE 2

| | Comparative | Comparative | |
|---|---|---|---|
| | Example 1 | Example 2 | Example 3 |
| Cold water (5° C.) (g) | 174 | 174 | 174 |
| Texturized proteins (g) | 70 | 70 | 70 |
| Coconut oil (melted) (g) | 50 | 0 | 0 |
| Sunflower oil (g) | 0 | 50 | 0 |
| Fat A (melted) (g) | 0 | 0 | 50 |
| Stabilizer blend (g) | 25.8 | 25.8 | 25.8 |
| Ice water (1-3° C.) (g) | 96.2 | 96.2 | 96.2 |
| Flavours (g) | 4 | 4 | 4 |
| Colours (g) | 8 | 8 | 8 |

Assessment of Burger Properties Before Cooking

Texture profile analysis (TPA) was used to determine the hardness, defined as the maximum peak force during the first compression cycle (first bite) which has often been substituted by the term firmness. TPA was performed on a TA.XT₂ machine (by Stable Micro Systems) fitted with a 5 kg load cell and a 25 mm Dia Cylinder Aluminium Probe (P/25). The machine was programmed to run with the following settings: pre-test speed: 1 mm/s; test speed: 5 mm/s; post-test speed: 5 mm/s; compression depth: 5 mm; time between cycles: 5 s; trigger type: automatic on 5 g; data acquisition rate: 200 pps. The test material was compressed two times in a reciprocating motion, mimicking the chewing movement in the mouth. A Force versus Time (and/or distance) graph was obtained, from which the desired information was obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

TABLE 3

| Property Before | Comparative | Comparative | |
|---|---|---|---|
| Cooking | Example 1 | Example 2 | Example 3 |
| Weight (g) | 100.07 | 98.44 | 99.93 |
| Diameter (cm) | 101.0 | 107.6 | 100.8 |
| Height (cm) | 14.4 | 18.3 | 14.5 |
| Hardness (g) | 1162 | 410 | 1029 |

Preferred values for the burgers before cooking are as follows: hardness from 400 to 5000 g, preferably from 400 to 1500 g. Comparative Example 1 and Example 3 according to the invention have hardness values correlating with good processability, typically needed to enable proper moulding of the burgers. However, Example 3 according to the invention is much lower in saturated fatty acid content. Comparative example 2 (based on sunflower oil) results in lower hardness values and a more oily dough. Comparative example 2 is barely acceptable since its hardness before cooking is barely sufficient. Comparative Example 1 and Example 3 have very good hardness scores. However, Example 3 has a far lower saturated fat content. Accordingly, Example 3 provides a solution that is as good with regard to hardness as the currently preferred state of the art for meat analogue compositions, whilst providing the additional benefit of being lower in saturated fat.

Properties of the Burgers of the Examples after Frying

The hardness of the burgers was measured by TPA using the same method as described above. The juiciness after frying was evaluated by the following method:
After frying, the sample is taken out of the pan and left to cool for 5 min (exactly 5 min);
The sample weight is documented;
Weight of the dish to collect the juice is documented (e.g. cup) and aeropress is positioned on the dish;
The sample is chopped into 36 pieces via 6 parallel and 6 perpendicular cuts;
Chopped samples are placed in the aeropress (Aerobie Model A80; use without fitter paper) and compressed using a force/weight of 7 kg for 5 min; and
Weight of extracted juice is recorded and juice per cooked mass is calculated.

TABLE 4

| Property After | Comparative | Comparative | |
|---|---|---|---|
| Frying | Example 1 | Example 2 | Example 3 |
| Weight (g) | 86.51 | 89.89 | 86.02 |
| Weight loss (g) | 13.56 | 8.55 | 13.91 |
| Yield (%) | 86 | 91 | 86 |
| Diameter (cm) | 94.0 | 101.7 | 93.3 |
| Height (cm) | 14.5 | 17.8 | 15.0 |
| Hardness (g) | 2308 | 916 | 2111 |
| Juice per cooked | 2.1 | 0.1 | 4.6 |
| mass (%) | | | |

Desirable values for hardness after frying are from 500 to 5000. All examples are within this range. Example 3 has comparable textural properties to comparative example 1, but at a significant lower content of saturated fatty acids. Secondly, Example 3 according to the invention has the highest percentage of juice per cooked mass. The hardness value for Comparative example 2 is only just acceptable, whereas the hardness values for Comparative Example 1 and Example 3 are much better. Example 3 provides the benefits over the state of the art (i.e. Comparative Example 1) of lower saturated fat content per unit weight, but also improved juiciness.

### Example 2

Fat B was prepared by chemical interesterification of a blend of 71 wt % shea stearin and 29 wt % coconut oil. Subsequently fat B was crystallised into solid fat flakes with a melting point of 42° C. The solid fat flakes enable convenient and easy handling and are especially developed for use in plant-based meat alternatives. Various properties of Fat B are shown in Table 5 below.

TABLE 5

| | Fat B |
|---|---|
| Fatty acid residue | |
| concentrations (wt %) | |
| C4:0 | 0.0 |
| C6:0 | 0.2 |
| C8:0 | 2.3 |
| C10:0 | 1.7 |
| C12:0 | 13.9 |
| C14:0 | 5.3 |
| C16:0 | 4.4 |
| C18:0 | 44.5 |
| C18:1c | 24.0 |
| C18:1tr | 0.0 |
| C18:2c | 2.2 |
| C18:2tr | 0.0 |
| C18:3 | 0.0 |
| C20:0 | 1.2 |
| SAFA | 73.7 |
| Carbon Number | |
| 26 | 0.0 |
| 28 | 0.0 |
| 30 | 0.0 |
| 32 | 0.2 |
| 34 | 0.3 |
| 36 | 0.6 |
| 38 | 1.9 |
| 40 | 2.0 |
| 42 | 5.2 |
| 44 | 7.2 |
| 46 | 5.8 |
| 48 | 22.4 |
| 50 | 9.3 |
| 52 | 7.1 |
| 54 | 36.4 |
| 56 | 2.0 |
| CN46 + 48 | 28.2 |
| St2M | 11.4 |
| SFC10° C. | 78 |
| SFC20° C. | 55 |
| SFC30° C. | 30 |
| SFC35° C. | 15 |
| SFC40° C. | 10 |

Fat B can be mixed into meat dough (i.e. mixed with the other components of the meat analogue composition) to provide visible solid fat structures (i.e. a marbling effect) and to increase the heterogeneity of the surfaces of the burgers.

Burger patties were prepared according to the recipe in Table 6.

TABLE 6

| | Comparative | |
|---|---|---|
| | Example 4 | Example 5 |
| Cold water (5° C.) (g) | 174 | 174 |
| Texturized proteins (g) | 70 | 70 |
| Coconut oil (melted) (g) | 50 | 0 |
| Sunflower oil (g) | 0 | 26 |
| Fat B (flakes, 20° C.) (g) | 0 | 24 |
| Stabilizer blend (g) | 25.8 | 25.8 |
| Ice water (1-3° C.) (g) | 96.2 | 96.2 |
| Flavours (g) | 4 | 4 |
| Colours (g) | 8 | 8 |

1. The texturised proteins⁺⁺ were hydrated with cold water (5° C.) according to the quantities shown in Table 1 and further hydrated for at least 30 minutes in cold storage (5° C.);
2. All other ingredients in powder form (stabilizer blend⁺⁺⁺ and flavours) were mixed and hydrated with ice water (1-3° C.) by blending for at least 1 minute, following which they were stored in a fridge for at least 30 minutes;
3. The hydrated texturized proteins were chopped for 20 seconds at low speed;
4. The ingredients from steps 2 and 3 and any further ingredients (e.g. colours, fats in molten form, oils, except for the fat flakes) according to the quantities shown in Table 5 were combined at room temperature and the resulting dough blended for about 1.5 mins; fat flakes (where present) were added and the resulting dough blended for another 1 min
5. The dough was rested in a fridge (operating at a temperature from 2 to 5° C.) for at least 30 minutes;
6. Burgers (diameter 8 cm; height 2 cm; weight 100 g) were made from this dough and stored in the fridge (operating at a temperature from 2 to 5° C.) prior to cooking; and
7. Burgers were cooked by heating on a frying pan with sunflower oil (5 g) for 6 minutes (4 times 1.5 minutes).

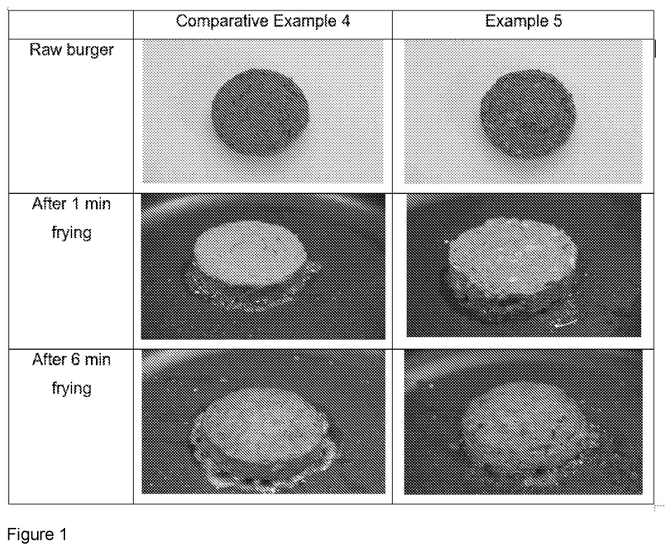

The burgers prepared are shown in FIG. 1. It can be seen that burgers according to the invention contain visible fat particles and have a more heterogeneous surface both before, during and after cooking when compared to burgers prepared containing just melted coconut oil. The visible fat particles resemble the look and feel of real meat. The burgers containing melted coconut oil do not contain visible fat structures and are far more homogenous, less resembling the look and feel of real meat. The burgers according to the invention also contain lower amounts of saturated fat per unit weight in comparison to the burger containing coconut oil.

Whilst in theory, it may be possible to include solid brittle coconut particles in burgers to try and provide the marbling effect shown in Example 5 and FIG. 1, an advantage of using the fat compositions for use in the present invention is that the fat compositions have improved processability in comparison to coconut oil due to their higher melting points, meaning that said fat compositions and other burger ingredients can be processed at higher temperatures and still provide the marbling effect shown in Example 5 of FIG. 1. The fat compositions of the invention can be processed to provide the marbling effect at temperatures that coconut oil would melt at meaning that no marbling effect is provided by the coconut oil.

### Example 3

Fat A was pre-crystallised (′plasticized) using a series of three scraped surface heat exchangers, followed by a pin rotor. The start temperature was about 58° C. and the exit temperatures after respectively the three scraped surface heat exchangers and the pin rotor were 27.4° C., 26.1° C., 19.4° C. and 24.6° C. The plasticized fat A was subsequently stored at 20° C.

The following burgers were prepared according to the recipe below and the procedure of Example 2, except for the frying step. Burgers were cooked by heating on a frying pan with sunflower oil (5 g) for approximately 9 minutes (6×1.5 min) until an internal temperature of about 74° C.

TABLE 7

| | | | | Ex 9 | |
|---|---|---|---|---|---|
| | | | Ex 8 | (±20% | Ex 10 |
| | Comp. Ex | Comp. Ex 7 | (±20% | fat | (±10% |
| | 6 (no fat) | (±20% oil) | fat) | cryst.) | fat) |
| Cold water (5° C.) (g) | 174 | 174 | 174 | 174 | 174 |
| Texturized proteins (g) | 70 | 70 | 70 | 70 | 70 |
| Sunflower oil (g) | 0 | 84 | 0 | 0 | 0 |
| Fat A (molten, 40° C.) | 0 | 0 | 84 | 0 | 42 |
| Fat A (crystallized, 20° C.) | 0 | 0 | 0 | 84 | 0 |
| Stabilizer blend (g) | 25.8 | 25.8 | 25.8 | 25.8 | 25.8 |
| Ice water (1-3° C.) (g) | 96.2 | 96.2 | 96.2 | 96.2 | 96.2 |
| Flavours (g) | 4 | 4 | 4 | 4 | 4 |
| Colours (g) | 8 | 8 | 8 | 8 | 8 |
| | Comp. Ex | | | | |
| | 6 | Comp. Ex 7 | Ex 8 | Ex 9 | Ex 10 |
| Hardness before frying (g) | 1301 | 675 | 2119 | 1878 | 1186 |
| Hardness after frying (g) | 2051 | 1124 | 1280 | 1286 | 1477 |
| Juice per cooked mass (%) | 1.2 | 2.2 | 6.7 | 4.9 | 1.5 |
| Juiciness score | 2 | 3 | 4 | 4 | 3 |

### Examples 8 and 9 According to the Invention

have hardness values correlating with good processability
have a high % Juice per cooked mass, correlating with a high sensorial score for juiciness. These results are better compared to the use of comparable amounts of sunflower oil (comparative example 7)

### Example 10 According to the Invention

has hardness value correlating with good processability
has a similar % juice per cooked mass and sensorial score for juiciness as comparative example 7 in which a double amount of oil is used. As a conclusion, Fat A could be used to decrease the amount of added fat in the burger, whilst still maintaining desirable sensory and performance characteristics of the burger.

The juiciness score given above is a score of from 0 (no juiciness) to 5 (most juicy) based on a sensorial evaluation of how much water/oil is secreted from the burger as juice whilst chewing.

1. A meat analogue composition comprising from 2% to 20% by weight of a fat composition; from 5% to 30% by weight of a non-animal protein; and from 30% to 70% by weight of water; wherein the fat composition comprises from 20% to 85% by weight of saturated fatty acid residues; from 10% to 50% by weight of stearic acid residues (C18:0); and from 2% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

2. A meat analogue composition according to claim 1, wherein the fat composition comprises from 20% to 70% by weight of saturated fatty acids.

3. A meat analogue composition according to claim 1, wherein the fat composition comprises less than 10% by weight of palm oil.

4. A meat analogue composition according to claim 1, wherein the fat composition is a non-hydrogenated fat composition.

5. A meat analogue composition according to claim 1, wherein the fat composition comprises 20% by weight or less of palmitic acid (C16:0).

6. A meat analogue composition according to claim 1, wherein the fat composition has a weight ratio of stearic acid (C18:0) to palmitic acid (C16:0) of from 1:1 to 12:1.

7. A meat analogue composition according to claim 1, wherein the fat composition has a weight ratio of lauric acid (C12:0) to stearic acid (C18:0) of from 1:4 to 4:1.

8. A meat analogue composition according to claim 1, wherein the fat composition comprises from 10% to 25% by weight lauric acid (C12:0); and/or from 15% to 45% by weight stearic acid (C18:0).

9. A meat analogue composition according to claim 1, wherein:
(i) the fat composition has a solid fat content (SFC) N40 of less than 10, measured on unstabilised fat according to ISO 8292-1;
(ii) the fat composition has an SFC N20 of from 35 to 60
as measured on the unstabilised fat according to ISO 8292-1; and/or
(iii) the fat composition has an SFC N30 of from 5 to 35
as measured on the unstabilised fat according to ISO 8292-1.

10. A meat analogue composition according to claim 1, wherein the fat composition comprises an interesterified fat.

11. A meat analogue composition according to claim 10, wherein the interesterified fat has been produced by chemical interesterification, enzymatic interesterification, or a combination thereof.

12. A meat analogue composition according to claim 10, wherein the interesterified fat is produced by an interesterification reaction that is stopped prior to reaching an equilibrium product distribution.

13. A meat analogue composition according to claim 1, wherein the fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

14. A meat analogue composition according to claim 1, wherein the fat composition comprises an interesterified blend of shea butter and coconut oil or an interesterified blend of shea stearin and coconut oil.

15. A meat analogue composition according to claim 1, wherein the fat composition comprises an interesterified blend of from 20% to 80% by weight of shea butter and from 20% to 80% by weight of coconut oil.

16. A meat analogue composition according to claim 1, wherein the fat composition comprises an interesterified blend of from 20% to 80% by weight of shea stearin and from 20% to 80% by weight of coconut oil.

17. A meat analogue composition according to claim 1, wherein the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil.

18. A meat analogue composition according to claim 1, wherein the fat composition comprises from 5 to 35 percent by weight of CN46 and CN48 triglycerides.

19. A meat analogue composition according to claim 1, wherein the fat composition comprises from 2 to 12 percent by weight of St2M triglycerides.

20. A meat analogue composition according to claim 1, wherein the nonanimal protein comprises protein derived from fungi, plants, or a combination thereof.

21. A meat analogue composition according to claim 1, wherein the nonanimal protein comprises plant protein.

22. A meat analogue composition according to claim 1, wherein the nonanimal protein comprises seitan, rice protein, mushroom protein, legume protein, tempeh, yam flour, tofu, mycoprotein, peanut flour, yuba, or a combination thereof.

23. A meat analogue composition according to claim 1, wherein the nonanimal protein comprises texturized vegetable proteins.

24. (canceled)

25. A meat analogue composition according to claim 1, wherein the meat analogue composition comprises a stabilizer blend.

26. (canceled)

27. A meat analogue composition according to claim 25, wherein the stabilizer blend comprises vegetable derived protein, vegetable fibre and a polysaccharide.

28. A meat analogue composition according to claim 1, wherein the meat analogue composition comprises one or more flavouring additives.

29. (canceled)

30. A meat analogue composition according to claim 1, wherein the composition further comprises one or more of: i) polysaccharides and/or modified polysaccharides.

31-38. (canceled)

39. A meat analogue composition according to claim 1, wherein the fat composition comprises an interesterified blend and at least one additional fat or oil.

40. A meat analogue composition according to claim 39, wherein the fat composition comprises the interesterified blend in an amount of from 50% to 80% by weight of the fat composition and a total amount of additional fat or oil in an amount of from 20% to 50% by weight of the fat composition.

41. A meat analogue composition according to claim 39, wherein the fat composition comprises the interesterified blend in an amount of from 60% to 80% by weight of the fat composition and a total amount of additional fat or oil in an amount of from 20% to 40% by weight of the fat composition.

42. A food product comprising a meat analogue composition according to claim 1.

43-54. (canceled)

55. A process of manufacturing a meat analogue composition according to claim 1, wherein the process comprises:
(a) providing a mixture of water and non-animal protein;
(b) combining the mixture from step (a) with the fat composition and optionally one or more additional components to form the meat analogue composition; and
(c) optionally forming the meat analogue composition into food products.

56-58. (canceled)
